(19) United States
(12) Patent Application Publication
(10) Pub. No.: US 2011/0111302 A1
(43) Pub. Date: May 12, 2011

(54) ELECTRODE PLATE FOR NONAQUEOUS ELECTROLYTE SECONDARY BATTERY, METHOD FOR FABRICATING THE SAME, AND NONAQUEOUS ELECTROLYTE SECONDARY BATTERY

(76) Inventors: Toshitada Sato, Osaka (JP); Yoshiyuki Muraoka, Osaka (JP)

(21) Appl. No.: 13/002,611

(22) PCT Filed: Dec. 17, 2009
(86) PCT No.: PCT/JP2009/006982

§ 371 Date: Jan. 4, 2011

(30) Foreign Application Priority Data
Mar. 16, 2009 (JP) 2009-062857

(51) Int. Cl. H01M 4/131; H01M 4/1391

(52) U.S. Cl. 429/231.1; 429/209; 29/623.5

(57) ABSTRACT

Winding dislocation in forming an electrode group of a nonaqueous electrolyte secondary battery is prevented.

An electrode plate for nonaqueous electrolyte secondary battery includes: a current collector; and an active material mixture layer including an active material and a binder on the current collector, wherein elongation at break is 3% or more, a dynamic hardness at a surface of the active material mixture layer is 4.5 or larger, and a dynamic hardness in an interior of the active material mixture layer is larger than that at the surface of the active material mixture layer by 0.8 or more.

### TECHNICAL FIELD

The present invention relates to electrode plates for nonaqueous electrolyte secondary batteries, methods for fabricating the same, and nonaqueous electrolyte secondary batteries.

### BACKGROUND ART

To meet, for example, recent demands for employing DC power supplies for large tools, small and lightweight secondary batteries capable of performing rapid charge and large-current discharge have been required, and have also been expected to be used on vehicles in consideration of environmental issues. Examples of typical batteries satisfying such demands include a nonaqueous electrolyte secondary battery employing, as a negative electrode material, an active material such as lithium metal or a lithium alloy or a lithium intercalation compound in which lithium ions are inserted in carbon serving as a host substance (here, the “host substance” refers to a substance capable of inserting or extracting lithium ions), and also employing, as an electrolyte, an aprotic organic solvent in which lithium salt such as LiClO₄ or LiPF₆ is dissolved.

This nonaqueous electrolyte secondary battery generally includes: a negative electrode in which the negative electrode material described above is supported on a negative electrode current collector; a positive electrode in which a positive electrode active material, e.g., lithium cobalt composite oxide, electrochemically reacting with lithium ions reversibly is supported on a positive electrode current collector; and a porous insulating layer (separator) carrying an electrolyte thereon and interposed between the negative electrode and the positive electrode to prevent short-circuit from occurring between the negative electrode and the positive electrode.

The positive and negative electrodes formed in the form of sheet or foil are stacked, or wound in a spiral, with the porous insulating layer interposed therebetween to form a power-generating element. This power-generating element is placed in a battery case made of metal such as stainless steel, iron plated with nickel, or aluminium. Thereafter, the electrolyte is poured in the battery case, and then a lid is fixed to the opening end of the battery case to seal the battery case. In this manner, a nonaqueous electrolyte secondary battery is fabricated.

### CITATION LIST

### Patent Document

PATENT DOCUMENT 1: Japanese Patent Publication No. H05-182692

### SUMMARY OF THE INVENTION

### Technical Problem

Generally, a method for increasing the capacity of the nonaqueous electrolyte secondary battery (hereinafter also simply referred to as a “battery”) is to increase the density of the positive electrode and the negative electrode. In this method, however, electrode plates of the positive electrode and the negative electrode tend to be hardened. In particular, the hardening of the positive electrode becomes a factor causing so-called electrode plate breakage in which the electrode plate cannot endure bending stress applied in winding the positive electrode, the negative electrode, and a separator to form an electrode group, and breaks.

Moreover, since the positive electrode having a high density has experienced a large rolling stress, the active material on a surface of the electrode plate is broken or crushed, so that the positive electrode has a very smooth surface. Such an electrode plate is very slippery on the separator facing the electrode plate, so that winding dislocation occurs in forming a plate pack, which becomes a factor of defects.

In view of the above discussed problems, it is an objective of the present invention to provide a means for reducing electrode plate breakage and winding dislocation in forming an electrode group without reducing the capacity of an nonaqueous electrolyte secondary battery.

### Solution to the Problem

To achieve the above objective, an electrode plate for a nonaqueous electrolyte secondary battery of the present invention includes: a current collector; and an active material mixture layer including an active material and a binder on the current collector, wherein elongation at break is 3% or larger, a dynamic hardness at a surface of the active material mixture layer is 4.5 or larger, and a dynamic hardness in an interior of the active material mixture layer is larger than that at the surface of the active material mixture layer by 0.8 or more.

The active material may be a lithium-containing transition metal oxide, and the binder may be a polymeric material containing fluorine.

The current collector is preferably an aluminium alloy foil containing iron.

A method for fabricating an electrode plate for a nonaqueous electrolyte secondary battery of the present invention includes: (A) forming an active material mixture layer including an active material which is a lithium-containing transition metal oxide and a binder which is a polymeric material containing fluorine on a current collector which is an aluminium alloy foil containing iron; and (B) heating the active material mixture layer such that a temperature at a surface of the active material mixture layer is higher than that in an interior of the active material mixture layer; wherein after (B), a dynamic hardness at the surface of the active material mixture layer is 4.5 or larger, and a dynamic hardness in the interior of the active material mixture layer is larger than that at the surface of the active material mixture layer by 0.8 or more.

In (B), the active material mixture layer can be laid on (brought into contact with) a heated roll to increase the temperature at the surface.

In (B), the active material mixture layer can be laid on (brought into contact with) a heated sheet to increase the temperature at the surface.

A nonaqueous electrolyte secondary battery of the present invention includes any one of the electrode plates described above as a positive electrode plate.

### Advantages of the Invention

In an electrode plate for a nonaqueous electrolyte secondary battery and a method for fabricating the same according to the present invention, heat treatment is performed on the surface of the electrode plate, so that the electrode plate breakage and winding dislocation in forming a plate pack can be reduced without reducing the capacity of the battery.

### BRIEF DESCRIPTION OF THE DRAWINGS

FIG. 1 is a longitudinal cross-sectional view illustrating a structure of a nonaqueous electrolyte secondary battery according to an embodiment.

FIG. 2 is an enlarged cross-sectional view illustrating a structure of an electrode group.

FIG. 3 is a view schematically illustrating measurement of a tensile extension percentage.

### DESCRIPTION OF EMBODIMENTS

Prior to description of a preferred embodiment of the present invention, the logic that the present invention was accomplished will be described.

The inventors of the present application have made various examinations on the above described problems. The inventors found that after compressing the electrode plate by applying pressure to increase its density, the heat treatment means of, for example, bringing a heated element into contact with the surface of the electrode plate is used to prevent electrode plate breakage and winding dislocation.

For heat treatment, disclosed is a technique of, for example, performing heat treatment on a positive electrode or a negative electrode at a temperature higher than the recrystallizing temperature of a binder and lower than the decomposition temperature of the binder before the positive and negative electrodes are stacked or wound with a porous insulating layer interposed therebetween, for the purpose of reducing peeling of an electrode material from a current collector during the stacking or winding of the electrodes or making the adhesiveness of the electrode material to the current collector less susceptible to degradation (see PATENT DOCUMENT 1, for example).

Here, heat treatment was performed using hot air as a general heat treatment means in the above mentioned temperature range, resulting in the occurrence of a phenomenon in which the discharge capacity of an active material decreased. It was found that the phenomenon occurred because a binder adhering active materials to each other, an active material to a conductive agent, or an active material and a conductive agent to a current collector was melted or softened, thereby covering a part of a surface of the active material, which prevented permeation of Li ions. Then, the inventors of the present application intensively studied to prevent electrode plate breakage and winding dislocation while maintaining the discharge capacity. As a result, the inventors of the present application achieved the present invention.

Embodiments of the present invention will be described below with reference to the drawings. Note that the present invention is not limited to the embodiments below.

### FIRST EMBODIMENT

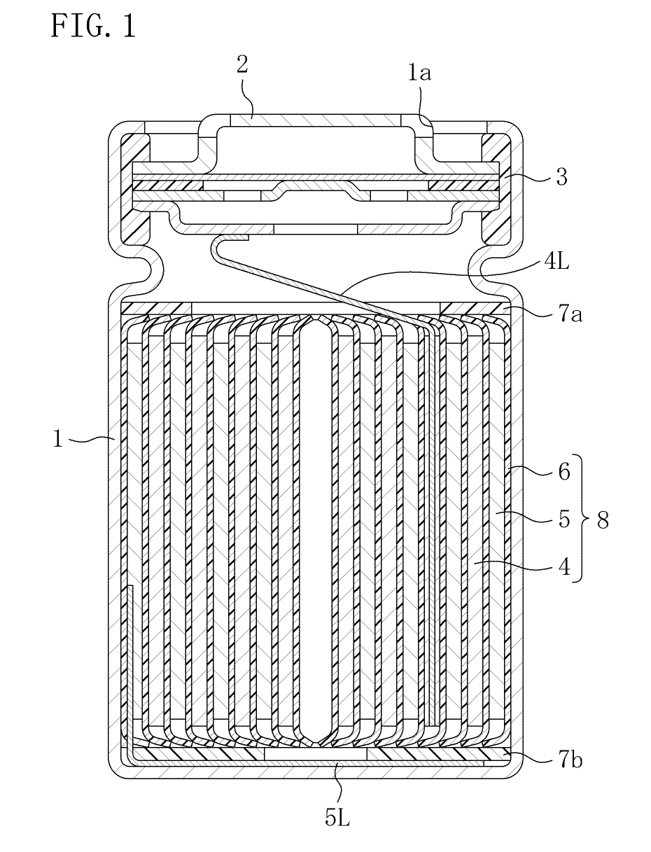

FIG. 1 is a longitudinal cross-sectional view schematically illustrating a structure of a nonaqueous electrolyte secondary battery according to a first embodiment.

As illustrated in FIG. 1, the nonaqueous electrolyte secondary battery of this embodiment includes a battery case 1 made of, for example, stainless steel, and an electrode group 8 placed in the battery case 1.

An opening 1a is formed in the upper face of the battery case 1. A sealing plate 2 is crimped to the opening 1a with a gasket 3 interposed therebetween, thereby sealing the opening 1a.

The electrode group 8 includes a positive electrode 4, a negative electrode 5, and a porous insulating layer (separator) 6 made of, for example, polyethylene. The positive electrode 4 and the negative electrode 5 are wound in a spiral with the separator 6 interposed therebetween. An upper insulating plate 7a is placed on top of the electrode group 8. A lower insulating plate 7b is placed on the bottom of the electrode group 8.

One end of a positive electrode lead 4L made of aluminium is attached to the positive electrode 4. The other end of the positive electrode lead 4L is attached to the sealing plate 2 also serving as a positive electrode terminal. One end of a negative electrode lead 5L made of nickel is attached to the negative electrode 5. The other end of the negative electrode lead 5L is connected to the battery case 1 also serving as a negative electrode terminal.

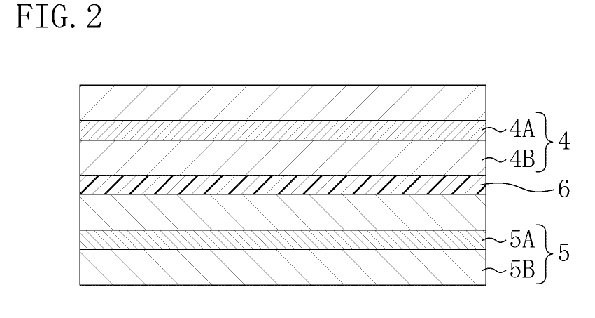

A structure of the electrode group 8 of the nonaqueous electrolyte secondary battery of the first embodiment is now described with reference to FIG. 2. FIG. 2 is an enlarged cross-sectional view illustrating the structure of the electrode group 8.

As illustrated in FIG. 2, the positive electrode 4 is an electrode plate including a positive electrode current collector 4A and a positive electrode mixture layer 4B. The positive electrode current collector 4A is a conductive member in the shape of a plate, specifically is made of, for example, a material mainly containing aluminium. The positive electrode mixture layer 4B is provided on surfaces (both surfaces) of the positive electrode current collector 4A, contains a positive electrode active material (e.g., lithium composite oxide) and a binder in addition to the positive electrode active material, and preferably further contains a conductive agent, and the like.

As illustrated in FIG. 2, the negative electrode 5 is an electrode plate including a negative electrode current collector 5A and a negative electrode mixture layer 5B. The negative electrode current collector 5A is a conductive member in the shape of a plate. The negative electrode mixture layer 5B is provided on surfaces (both surfaces) of the negative electrode current collector 5A, contains a negative electrode active material, and preferably contains a binder in addition to the negative electrode active material.

As illustrated in FIG. 2, the separator 6 is interposed between the positive electrode 4 and the negative electrode 5.

The positive electrode 4, the negative electrode 5, the separator 6, and a nonaqueous electrolyte forming the nonaqueous electrolyte secondary battery of this embodiment are now described in detail.

First, the positive electrode is described in detail.

—Positive Electrode—

The positive electrode current collector 4A and the positive electrode mixture layer 4B forming the positive electrode 4 will be described sequentially.

The positive electrode current collector 4A uses a long conductor substrate having a porous or non-porous structure. The positive electrode current collector 4A is made of a metal foil mainly containing aluminium. In this embodiment, a foil of an aluminium-iron alloy is preferably used. The iron content in the alloy is preferably in the range from 1.0 weight percent (wt. %) to 2.0 wt. %. Using such an alloy foil makes it possible to perform heat treatment while limiting the decrease in capacity due to melting or softening of the binder to a lesser extent. The thickness of the positive electrode current collector 4A is not specifically limited, but is preferably in the range from 1 μm to 500 μm, both inclusive, and more preferably in the range from 10 μm to 20 μm, both inclusive. In this manner, the thickness of the positive electrode current collector 4A is set in the range described above, thus making it possible to reduce the weight of the positive electrode 4 while maintaining the strength of the positive electrode 4.

The positive electrode active material, the binder, and the conductive agent contained in the positive electrode mixture layer 4B are now described sequentially.

<Positive Electrode Active Material>

Examples of the positive electrode active material include LiCoO₂, LiNiO₂, LiMnO₂, LiCoNiO₂, LiCoMO_{z}, LiNiMO_{z}, LiNi_{1/3}Co_{1/3}Mn_{1/3}O₂, LiMn₂O₄, LiMnMO₄, LiMePO₄, Li₂MePO₄F (where M is at least one of Na, Mg, Sc, Y, Mn, Fe, Co, Ni, Cu, Zn, Al, Cr, Pb, Sb, and B, and Me is a metallic element containing at least one element selected from a group consisting of Fe, Mn, Co, and Ni). In these lithium-containing compounds, an element may be partially substituted with an element of a different type. In addition, the positive electrode active material may be a positive electrode active material subjected to a surface process using a metal oxide, a lithium oxide, or a conductive agent, for example. Examples of this surface process include hydrophobization.

The average particle diameter of the positive electrode active material is preferably in the range from 5 μm to 20 μm, both inclusive.

If the average particle diameter of the positive electrode active material is less than 5 μm, the surface area of the active material particles is very large, and thus the amount of the binder satisfying the adhesive strength at which the positive electrode plate can satisfactory be handled is extremely large. For this reason, the amount of the active material per electrode plate decreases, reducing the capacity. On the other hand, when the average particle diameter exceeds 20 μm, a coating streak is likely to occur during coating of the positive electrode current collector with positive electrode material mixture slurry. To prevent this, the average particle diameter of the positive electrode active material is preferably in the range from 5 μm to 20 μm, both inclusive.

### <Binder>

Examples of the binder include poly vinylidene fluoride (PVDF), polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyether sulphone, hexafluoropolypropylene, styrene-butadiene rubber, and carboxymethyl cellulose. Examples of the binder also include a copolymer of two or more materials selected from the group consisting of tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene, and a mixture of two or more materials selected from these materials.

Among the above-listed binders, PVDF and a derivative thereof are particularly chemically stable in a nonaqueous electrolyte secondary battery, and each sufficiently bonds the positive electrode mixture layer 4B and the positive electrode current collector 4A together, and also bonds the positive electrode active material, the binder, and the conductive agent forming the positive electrode mixture layer 4B. Accordingly, excellent cycle characteristics and high discharge performance can be obtained. Thus, PVDF or a derivative thereof is preferably used as the binder of this embodiment. In addition, PVDF and a derivative thereof are available at low cost and, therefore, are preferable. To form a positive electrode employing PVDF as a binder, PVDF, for example, may be dissolved in N methylpyrrolidone, or PVDF powder may be dissolved in positive electrode material mixture slurry, for example, during the formation of the positive electrode.

### <Conductive Agent>

Examples of the conductive agent include graphites such as natural graphite and artificial graphite, carbon blacks such as acetylene black (AB), Ketjen black, channel black, furnace black, lamp black, and thermal black, conductive fibers such as carbon fiber and metal fiber, metal powders such as carbon fluoride and aluminium, conductive whiskers such as zinc oxide and potassium titanate, conductive metal oxides such as titanium oxide, and organic conductive materials such as a phenylene derivative.

Then, the negative electrode is described in detail.

—Negative Electrode—

The negative electrode current collector 5A and the negative electrode mixture layer 5B forming the negative electrode 5 are now described sequentially.

As the negative electrode current collector 5A, a long conductive substrate having a porous or non-porous structure is used. The negative electrode current collector 5A is made of, for example, stainless steel, nickel, or copper. The thickness of the negative electrode current collector 5A is not specifically limited, but is preferably in the range from 1 μm to 500 μm, both inclusive, and more preferably in the range from 10 μm to 20 μm, both inclusive. In this manner, the thickness of the negative electrode current collector 5A is set in the range described above, thus making it possible to reduce the weight of the negative electrode 5 while maintaining the strength of the negative electrode 5.

The negative electrode mixture layer 5B preferably contains a binder, in addition to the negative electrode active material.

The negative electrode active material contained in the negative electrode mixture layer 5B is now described.

<Negative Electrode Active Material>

Examples of the negative electrode active material include metal, metal fiber, a carbon material, oxide, nitride, a silicon compound, a tin compound, and various alloys. Examples of the carbon material include various natural graphites, coke, partially-graphitized carbon, carbon fiber, spherical carbon, various artificial graphites, and amorphous carbon.

Since simple substances such as silicon (Si) and tin (Sn), silicon compounds, and tin compounds have high capacitance density, it is preferable to use such materials as the negative electrode active material. Examples of the silicon compound include SiOₓ (where 0.05<x<1.95) and a silicon alloy and a silicon solid solution obtained by substituting part of

Si with at least one of the elements selected from the group consisting of B, Mg, Ni, Ti, Mo, Co, Ca, Cr, Cu, Fe, Mn, Nb, Ta, V, W, Zn, C, N, and Sn. Example of the tin compound include Ni₂Sn₄, Mg₂Sn, SnOₓ (where 0<x<2), SnO₂, and SnSiO₃. One of the examples of the negative electrode active material may be used solely, or two or more of them may be used in combination.

Moreover, a negative electrode in which the above mentioned silicon, tin, silicon compound, or tin compound is deposited in thin film form on the negative electrode current collector 5A is also possible.

Then, the separator is described in detail.

—Separator—

Examples of the separator 6 interposed between the positive electrode 4 and the negative electrode 5 include a microporous thin film, woven fabric, and nonwoven fabric which have high ion permeability, a given mechanical strength, and a given insulation property. In particular, polyolefin such as polypropylene or polyethylene is preferably used as the separator 6. Since polyolefin has high durability and a shutdown function, the safety of the lithium ion secondary battery can be enhanced. The thickness of the separator 6 is generally in the range from 10 μm to 300 μm, both inclusive, and preferably in the range from 10 μm to 40 μm, both inclusive. The thickness of the separator 6 is more preferably in the range from 15 μm to 30 μm, both inclusive, and much more preferably in the range from 10 μm to 25 μm, both inclusive. When using a microporous thin film as the separator 6, this microporous thin film may be a single-layer film made of a material of one type, or may be a composite film or a multilayer film made of one or more types of materials. The porosity of the separator 6 is preferably in the range from 30% to 70%, both inclusive, and more preferably in the range from 35% to 60%, both inclusive. The porosity here is the volume ratio of pores to the total volume of the separator.

Then, the nonaqueous electrolyte is described in detail.

—Nonaqueous Electrolyte—

The nonaqueous electrolyte may be a liquid nonaqueous electrolyte, a gelled nonaqueous electrolyte, or a solid nonaqueous electrolyte.

The liquid nonaqueous electrolyte (i.e., the nonaqueous electrolyte) contains an electrolyte (e.g., lithium salt) and a nonaqueous solvent in which this electrolyte is to be dissolved.

The gelled nonaqueous electrolyte contains a nonaqueous electrolyte and a polymer material supporting the nonaqueous electrolyte. Examples of this polymer material include polyvinylidene fluoride, polyacrylonitrile, polyethylene oxide, polyvinyl chloride, polyacrylate, and polyvinylidene fluoride hexafluoropropylene.

The solid nonaqueous electrolyte contains a solid polymer electrolyte.

The nonaqueous electrolyte is now described in further detail.

As a nonaqueous solvent in which an electrolyte is to be dissolved, a known nonaqueous solvent may be used. The type of this nonaqueous solvent is not specifically limited, and examples of the nonaqueous solvent include cyclic carbonate, chain carbonate, and cyclic carboxylate. Cyclic carbonate may be propylene carbonate (PC) or ethylene carbonate (EC). Chain carbonate may be diethyl carbonate (DEC), ethylmethyl carbonate (EMC), or dimethyl carbonate (DMC). Cyclic carboxylate may be γ-butyrolactone (GBL) or γ-valerolactone (GVL). One of the examples of the nonaqueous solvent may be used solely, or two or more of them may be used in combination.

Examples of the electrolyte to be dissolved in the nonaqueous solvent include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylate, LiCl, LiBr, LiI, chloroborane lithium, borates, and imidates. Examples of the borates include bis(1,2-benzene diolate(2-)-O,O′)lithium borate, bis(2,3 -naphthalene diolate(2-)-O,O′)lithium borate, bis(2,2′-biphenyl diolate(2-)-O,O′)lithium borate, and bis(5-fluoro-2-olate-1-benzenesulfonic acid-O,O′)lithium borate. Examples of the imidates include lithium bistrifluoromethanesulfonimide ((CF₃SO₂)₂NLi), lithium trifluoromethanesulfonate nonafluorobutanesulfonimide (LiN(CF₃SO₂)(C₄F₉SO₂)), and lithium bispentafluoroethanesulfonimide ((C₂F₅SO₂)₂NLi). One of these electrolytes may be used solely, or two or more of them may be used in combination.

The amount of the electrolyte dissolved in the nonaqueous solvent is preferably in the range from 0.5 mol/m³ to 2 mol/m³, both inclusive.

The nonaqueous electrolyte may contain an additive which is decomposed on the negative electrode and forms thereon a coating having high lithium ion conductivity to enhance the charge-discharge efficiency, for example, in addition to the electrolyte and the nonaqueous solvent. Examples of the additive having such a function include vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinyl ethylene carbonate (VEC), and divinyl ethylene carbonate. One of the additives may be used solely, or two or more of them may be used in combination. Among the additives, at least one selected from the group consisting of vinylene carbonate, vinyl ethylene carbonate, and divinyl ethylene carbonate is preferable. In the above-listed additives, hydrogen atoms may be partially substituted with fluorine atoms.

The nonaqueous electrolyte may further contain, for example, a known benzene derivative which is decomposed during overcharge and forms a coating on the electrode to inactivate the battery, in addition to the electrolyte and the nonaqueous solvent. The benzene derivative having such a function preferably includes a phenyl group and a cyclic compound group adjacent to the phenyl group. Examples of the benzene derivative include cyclohexylbenzene, biphenyl, and diphenyl ether. Examples of the cyclic compound group included in the benzene derivative include a phenyl group, a cyclic ether group, a cyclic ester group, a cycloalkyl group, and a phenoxy group. One of the benzene derivatives may be used solely, or two or more of them may be used in combination. However, the content of the benzene derivative is preferably 10 vol % or less of the total volume of the nonaqueous solvent.

The structure of the nonaqueous electrolyte secondary battery of this embodiment is not limited to the structure illustrated in FIG. 1. For example, the nonaqueous electrolyte secondary battery of this embodiment is not limited to a cylindrical shape as shown in FIG. 1, and may be prism-shaped or a high-power lithium ion secondary battery. The structure of the electrode group 8 is not limited to the spiral provided by winding the positive electrode 4 and the negative electrode 5 with the separator 6 interposed therebetween (see FIG. 1). Alternatively, the positive and negative electrodes may be stacked with the separator interposed therebetween.

A method for fabricating a lithium ion secondary battery as an example of the nonaqueous electrolyte secondary battery according to the first embodiment will be described below with reference to FIG. 1.

Methods for forming a positive electrode 4, a negative electrode 5, and a battery are now described sequentially.

—Method for Forming Positive Electrode—

A positive electrode 4 is formed in the following manner. For example, a positive electrode active material, a binder (which is preferably made of PVDF or a derivative thereof or a rubber-based binder as described above), and a conductive agent are first mixed in a liquid component, thereby preparing positive electrode material mixture slurry. Then, this positive electrode material mixture slurry is applied onto the surface of a positive electrode current collector 4A made of a foil mainly made of aluminium and containing iron, and is dried. Thereafter, the resultant positive electrode current collector 4A is rolled (compressed), thereby forming a positive electrode (positive electrode plate) having a given thickness. Subsequently, the positive electrode is subjected to heat treatment at a given temperature for a given period of time.

The heat treatment on the positive electrode is carried out, for example, by bringing a heated roll at a given temperature into contact with the positive electrode, or by preparing two heated sheets and sandwiching the positive electrode provided between the two heated sheets.

The heat treatment performed in the above described manner results in a heat history having a gradient between a surface of a positive electrode mixture and a portion of the positive electrode mixture which is close to the current collector. That is, the surface is treated at a higher temperature, and the mixture close to the current collector is subjected to the heat treatment at a lower temperature. When the mixture layer close to the surface is subjected to a high temperature, a binder adhering positive electrode active materials to each other, or a positive electrode active material to a conductive agent is softened or melted, so that the mixture layer becomes fragile (dynamic hardness is larger), which leads to a high friction coefficient. The dynamic hardness at the surface of the positive electrode mixture layer differs from that in the interior of the positive electrode mixture layer. As a result, when forming an electrode group, the electrode is less slippery on the separator, so that winding dislocation less likely occurs.

Moreover, the positive electrode current collector is softened through the heat treatment, so that it becomes easy to bend the positive electrode current collector, thereby allowing electrode plate breakage to be reduced.

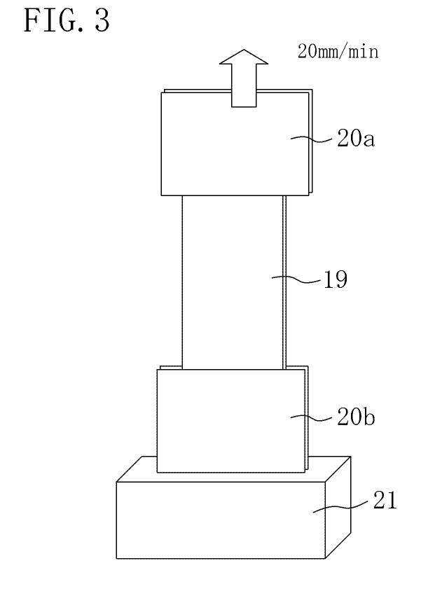

Softening of a positive electrode can be checked by measuring the tensile extension percentage as follows. First, an electrode plate is cut to have a width of 15 mm and an effective length (i.e., the length of an effective portion) of 20 mm, thereby forming a sample electrode plate 19 as illustrated in FIG. 3. Then, one end of the sample electrode plate 19 is placed on a lower chuck 20b supported by a base 21, whereas the other end of the sample electrode plate 19 is placed at an upper chuck 20a connected to a load mechanism (not shown) via a load cell (a load converter, not shown, for converting a load into an electrical signal), thereby holding the sample electrode plate 19. Subsequently, the upper chuck 20a is moved along the longitudinal direction of the sample electrode plate 19 at a speed of 20 mm/min (see, e.g., the arrow in FIG. 3) to extend the sample electrode plate 19. At this time, the length of the sample electrode plate 19 immediately before the sample electrode plate 19 is broken is measured. Using the obtained length and the length (i.e., 20 mm) before the extension of the sample electrode plate 19, the tensile extension percentage of the positive electrode is calculated. The tensile load on the sample electrode plate 19 is detected from information obtained from the load cell.

The amount of the binder contained in the positive electrode material mixture slurry is preferably in the range from 3.0 vol % to 6.0 vol %, both inclusive, with respect to 100 vol % of the positive electrode active material. In other words, the amount of the binder contained in the positive electrode mixture layer is preferably in the range from 3.0 vol % to 6.0 vol %, both inclusive, with respect to 100 vol % of the positive electrode active material.

—Method for Forming Negative Electrode—

A negative electrode 5 is formed in the following manner. For example, a negative electrode active material and a binder are first mixed in a liquid component, thereby preparing negative electrode material mixture slurry. Then, this negative electrode material mixture slurry is applied onto the surface of a negative electrode current collector 5A, and is dried. Thereafter, the resultant negative electrode current collector 5A is rolled up, thereby forming a negative electrode having a given thickness. As the positive electrode, after rolling, the negative electrode may be subjected to heat treatment at a given temperature for a given time.

<Method for Fabricating Battery>

A battery is fabricated in the following manner. For example, as illustrated in FIG. 1, an aluminium positive electrode lead 4L is attached to a positive electrode current collector (see 4A in FIG. 2), and a nickel negative electrode lead 5L is attached to a negative electrode current collector (see 5A in FIG. 2). Then, a positive electrode 4 and a negative electrode 5 are wound with a separator 6 interposed therebetween, thereby forming an electrode group 8. Thereafter, an upper insulating plate 7a is placed on the upper end of the electrode group 8, and a lower insulating plate 7b is placed on the lower end of the electrode group 8. Subsequently, the negative electrode lead 5L is welded to a battery case 1, and the positive electrode lead 4L is welded to a sealing plate 2 including a safety valve operated with inner pressure, thereby housing the electrode group 8 in the battery case 1. Then, a nonaqueous electrolyte is poured in the battery case 1 under a reduced pressure. Lastly, an opening end of the battery case 1 is crimped to the sealing plate 2 with a gasket 3 interposed therebetween, thereby completing a battery.

The method for fabricating a nonaqueous electrolyte secondary battery according to this embodiment has the following features.

Examples will be described in detail below.

<Example, First Comparative Example>

In an example, Batteries 1-3 were fabricated. In a first comparative example, Batteries 4-6 were fabricated.

A method for fabricating Battery 1 is now described in detail.

(Battery 1)

(Formation of Positive Electrode)

First, LiNi_{0.82}Co_{0.15}Al_{0.03}O₂ having an average particle diameter of 10 μm was prepared.

Next, 4.5 vol % of acetylene black as a conductive agent with respect to 100 vol % of the positive electrode active material, a solution in which 4.7 vol % of polyvinylidene fluoride (PVDF) as a binder with respect to 100 vol % of the positive electrode active material was dissolved in a N-methyl pyrrolidone (NMP) solvent, and LiNi_{0.82}Co_{0.15}Al_{0.03}O₂ as the positive electrode active material were mixed, thereby obtaining positive electrode material mixture slurry.

This positive electrode material mixture slurry was applied onto both surfaces of aluminium-alloy foil containing iron at 1.4 wt. % and having a thickness of 15 μm as a positive electrode current collector, and was dried. Thereafter, the resultant positive electrode current collector whose both surfaces were coated with the dried positive electrode material mixture slurry was rolled, thereby obtaining a positive electrode plate in the shape of a plate having a thickness of 0.157 mm.

This positive electrode plate was then subjected to heat treatment with a heated roll. Here, the heat treatment with the heated roll was performed by bringing a heated roll at 200° C. into contact with the surface of the positive electrode plate for 3 seconds. In this manner, by setting the contact time (i.e., heat treatment time) during which the surface of the positive electrode plate is in contact with the heated roll, the surface temperature of the positive electrode plate can reach 190° C. The positive electrode plate was cut to have a width of 57 mm and a length of 564 mm, thereby obtaining a positive electrode having a thickness of 0.157 mm, a width of 57 mm, and a length of 564 mm.

(Formation of Negative Electrode)

First, flake artificial graphite was ground and classified to have an average particle diameter of about 20 μm.

Then, 3 parts by weight of styrene butadiene rubber as a binder and 100 parts by weight of a solution containing 1 wt. % of carboxymethyl cellulose as a binder were added to 100 parts by weight of flake artificial graphite as a negative electrode active material, and these materials were mixed, thereby preparing negative electrode material mixture slurry.

This negative electrode material mixture slurry was then applied onto both surfaces of copper foil with a thickness of 8 μm as a negative electrode current collector, and was dried. Thereafter, the resultant negative electrode current collector whose both surfaces were coated with the dried negative electrode material mixture slurry was rolled up, thereby obtaining a negative electrode plate in the shape of a plate having a thickness of 0.156 mm. This negative electrode plate was subjected to heat treatment with hot air in a nitrogen atmosphere at 190° C. for 8 hours. The negative electrode plate was then cut to have a width of 58.5 mm and a length of 750 mm, thereby obtaining a negative electrode having a thickness of 0.156 mm, a width of 58.5 mm, and a length of 750 mm.

(Preparation of Nonaqueous Electrolyte)

To a solvent mixture of ethylene carbonate and dimethyl carbonate in the volume ratio of 1:3 as a nonaqueous solvent, 5 wt. % of vinylene carbonate was added as an additive for increasing the charge/discharge efficiency of the battery, and LiPF₆ as an electrolyte was dissolved in a mole concentration of 1.4 mol/m³ with respect to the nonaqueous solvent, thereby obtaining a nonaqueous electrolyte solution.

(Fabrication of Cylindrical Battery)

First, a positive electrode lead made of aluminium was attached to the positive electrode current collector, and a negative electrode lead made of nickel was attached to the negative electrode current collector. Then, the positive electrode and the negative electrode were wound with a polyethylene separator interposed therebetween, thereby forming an electrode group.

Thereafter, an upper insulating film was placed at the upper end of the electrode group, and a lower insulating plate was placed at the bottom end of the electrode group. Subsequently, the negative electrode lead was welded to a battery case, and the positive electrode lead was welded to a sealing plate including a safety valve operated with inner pressure, thereby housing the electrode group in the battery case. Then, the nonaqueous electrolyte was poured in the battery case under reduced pressure. Lastly, an opening end of the battery case was crimped to the sealing plate with a gasket interposed therebetween, thereby completing a battery.

The battery including the positive electrode subjected to heat treatment at 200° C. for 3 seconds by the heated roll in the foregoing manner is hereinafter referred to as Battery 1 of the example.

(Battery 2)

Battery 2 of the example was fabricated in the same manner as for Battery 1 except that the heated roll was set to 250° C., and the positive electrode plate of Battery 2 was in contact with the heated roll for 1 second in Formation of Positive Electrode.

(Battery 3)

Battery 3 of the example was fabricated in the same manner as for Battery 1 except that the heated roll was set to 175° C., and the positive electrode plate of Battery 3 was in contact with the heated roll for 30 seconds in Formation of Positive Electrode.

(Battery 4)

Battery 4 of the first comparative example was fabricated in the same manner as for Battery 1 except that the heated roll was set to 200° C., and the positive electrode plate of Battery 4 was in contact with the heated roll for 60 seconds in Formation of Positive Electrode.

(Battery 5)

Battery 5 of the first comparative example was fabricated in the same manner as for Battery 1 except that the heated roll was set to 250° C., and the positive electrode plate of Battery 5 was in contact with the heated roll for 20 seconds in Formation of Positive Electrode.

(Battery 6)

Battery 6 of the first comparative example was fabricated in the same manner as for Battery 1 except that the heated roll was set to 175° C., and the positive electrode plate of Battery 6 was in contact with the heated roll for 3 seconds in Formation of Positive Electrode.

For each of Batteries 1-6, characteristics of the positive electrode were evaluated. The tensile extension percentage (elongation at break) of the positive electrode, and the dynamic hardness of the positive electrode mixture layer were each measured to evaluate the characteristics of the positive electrode. The measurements were carried out in the following manner.

<Measurement of Tensile Extension Percentage of Positive Electrode>

First, each of Batteries 1-6 was charged to a voltage of 4.25 V at a constant current of 1.45 A, and was continuously charged to a current of 50 mA at a constant voltage of 4.25 V. Then, each of resultant Batteries 1-6 was disassembled, and a positive electrode was taken out. This positive electrode was then cut to have a width of 15 mm and an effective length of 20 mm, thereby forming a sample positive electrode. Thereafter, one end of the sample positive electrode was fixed, and the other end of the sample positive electrode was extended along the longitudinal direction thereof at a speed of 20 mm/min. At this time, the length of the sample positive electrode immediately before breakage was measured. Using the obtained length and the length (i.e., 20 mm) before the extension of the sample positive electrode, the tensile extension percentage of the positive electrode was calculated. The tensile extension percentages (elongation at break) of the positive electrodes of Batteries 1-6 are shown in Table 1.

<Measurement of Dynamic Hardness>

First, each of the batteries was charged to a voltage of 4.25 V at a constant current of 1.45 A, and was continuously charged to a current of 50 mA at a constant voltage of 4.25 V. Then, each of the resultant batteries was disassembled, and a positive electrode was taken out. The dynamic hardness of the positive electrode mixture layer of this positive electrode was measured with Shimadzu Dynamic Ultra Micro Hardness Tester DUH-W201. Here, the dynamic hardness at the surface of the positive electrode was measured, and then the positive electrode mixture layer in the periphery of the measured position on the surface was removed until the thickness of the positive electrode mixture layer was reduced by approximately half.

At the removed position, the dynamic hardness in the interior of the mixture layer was measured. Results for the positive electrodes of Batteries 1-6 are shown in Table 1.

The battery capacity was measured for each of Batteries 1-6 in the following manner.

<Measurement of Battery Capacity>

Each of Batteries 1-6 was charged to a voltage of 4.2 V at a constant current of 1.4 A in an atmosphere of 25° C., and was continuously charged to a current of 50 mA at a constant voltage of 4.2 V. Then, the battery was discharged to a voltage of 2.5 V at a constant current of 0.56 A, and the capacity of the battery at this time was measured.

For each of Batteries 1-6, an electrode plate breakage evaluation and a winding dislocation evaluation were conducted in the following manner.

<Electrode Plate Breakage Evaluation>

Using a winding core with a diameter of 3 Ø, the positive electrode and the negative electrode were wound with the separator interposed therebetween with a tension of 0.12 N applied, thereby preparing 50 cells of each of the batteries. In each of the batteries, the number of cells in which positive electrodes were broken during winding among the 50 cells (i.e., the number of cells in which positive electrodes were broken per 50 cells) was counted. Results of the electrode plate breakage evaluation on each of Batteries 1-6 are shown in Table 1 below.

<Winding Dislocation Evaluation>

After actually forming batteries, but before pouring an electrolyte, a voltage of 250 V was applied using a constant voltage power supply, and a leakage examination was carried out. If winding dislocation occurred in a battery, that the battery was determined as detective in the leakage examination. Fifty pieces of each of the batteries were prepared. Among 50 pieces of each of the batteries, the number of batteries in which leakage occurred was counted. Results are shown in Table 1.

TABLE 1

| | | | | | | | | | The Number of | |
|---|---|---|---|---|---|---|---|---|---|---|
| | | | | | Extension | Dynamic Hardness | | Capacity/ | Electrode Plate | The Number |
| | | Binder | Temp. | Time | Percentage/% | Surface | Interior | mAh | Breakage | of Leakage |
| 1st Ex. | Battery 1 | PVDF | 200° C. | 3 sec. | 5.5 | 4.7 | 5.8 | 2850 | 0/50 | 0/50 |
| | Battery 2 | | 250° C. | 1 sec. | 6.5 | 4.5 | 5.8 | 2830 | 0/50 | 0/50 |
| | Battery 3 | | 175° C. | 30 sec. | 3 | 5 | 5.8 | 2890 | 0/50 | 0/50 |
| 1st Compar. | Battery 4 | | 200° C. | 60 sec. | 7 | 4.5 | 4.6 | 2760 | 0/50 | 0/50 |
| Ex. | Battery 5 | | 250° C. | 20 sec. | 7.5 | 4.4 | 4.5 | 2710 | 0/50 | 0/50 |
| | Battery 6 | | 175° C. | 3 sec. | 1.5 | 5.7 | 5.8 | 2900 | 8/50 | 4/50 |

<Second Comparative Example>

Batteries were fabricated using positive electrode mixture slurry containing 2.5 vol % of rubber binder with respect to 100 vol % of positive electrode active material using a rubber binder (BM500B produced by Zeon Corporation) instead of PVDF.

(Battery 7)

Battery 7 of a second comparative example was fabricated in the same manner as for Battery 1 except that a binder of the positive electrode was a rubber binder, the heated roll was set to 200° C., and the positive electrode plate of Battery 7 was in contact with the heated roll for 3 seconds in Formation of Positive Electrode.

(Battery 8)

Battery 8 of the second comparative example was fabricated in the same manner as for Battery 7 except that the heated roll was set to 250° C., and the positive electrode plate of Battery 8 was in contact with the heated roll for 1 second in Formation of Positive Electrode.

(Battery 9)

Battery 9 of the second comparative example was fabricated in the same manner as for Battery 7 except that the heated roll was set to 175° C., and the positive electrode plate of Battery 9 was in contact with the heated roll for 30 seconds in Formation of Positive Electrode.

For each of the batteries, the extension percentage and the dynamic hardness of the positive electrode and the battery capacity were measured, and an electrode plate breakage evaluation and a winding dislocation evaluation were conducted as in the first example and the first comparative example. Results are shown in Table 2.

TABLE 2

| | | | | | | | | | The Number of | |
|---|---|---|---|---|---|---|---|---|---|---|
| | | | | | Extension | Dynamic Hardness | | Capacity/ | Electrode Plate | The Number |
| | | Binder | Temp. | Time | Percentage/% | Surface | Interior | mAh | Breakage | of Leakage |
| 2nd Compar. | Battery 7 | Rubber Binder | 200° C. | 3 sec. | 6.5 | 1.2 | 1.3 | 2820 | 0/50 | 10/50 |
| Ex. | Battery 8 | | 250° C. | 1 sec. | 6.5 | 0.9 | 0.9 | 2770 | 0/50 | 9/50 |
| | Battery 9 | | 175° C. | 30 sec. | 6.5 | 1.3 | 1.5 | 2830 | 0/50 | 18/50 |

<Third Comparative Example>

Next, batteries were fabricated in the same manner as for Battery 1 except that the current collector was made of a pure aluminium foil instead of an iron-aluminium alloy foil.

(Battery 10)

Battery 10 of a third comparative example was fabricated in the same manner as for Battery 1 except that the positive electrode current collector of Battery 10 was made of a pure aluminium foil, the heated roll was set to 200° C., and the positive electrode plate of Battery 10 was in contact with the heated roll for 3 seconds in Formation of Positive Electrode.

(Battery 11)

Battery 11 of the third comparative example was fabricated in the same manner as for Battery 10 except that the heated roll was set to 250° C., and the positive electrode plate of Battery 11 was in contact with the heated roll for 1 second in Formation of Positive Electrode.

(Battery 12)

Battery 12 of the third comparative example was fabricated in the same manner as for Battery 10 except that the heated roll was set to 175° C., and the positive electrode plate of Battery 12 was in contact with the heated roll for 30 seconds in Formation of Positive Electrode.

(Battery 13)

Battery 13 of the third comparative example was fabricated in the same manner as for Battery 10 except that the heated roll was set to 200° C., and the positive electrode plate of Battery 13 was in contact with the heated roll for 60 seconds in Formation of Positive Electrode.

(Battery 14)

Battery 14 of the third comparative example was fabricated in the same manner as for Battery 10 except that the heated roll was set to 250° C., and the positive electrode plate of Battery 14 was in contact with the heated roll for 20 seconds in Formation of Positive Electrode.

(Battery 15)

Battery 15 of the third comparative example was fabricated in the same manner as for Battery 10 except that the heated roll was set to 175° C., and the positive electrode plate of Battery 15 was in contact with the heated roll for 3 seconds in Formation of Positive Electrode.

For each of the batteries, the extension percentage and the dynamic hardness of the positive electrode and the battery capacity were measured, and an electrode plate breakage evaluation and a winding dislocation evaluation were conducted as in the first example. Results are shown in Table 3.

TABLE 3

| | | | | | | | | | The Number of | |
|---|---|---|---|---|---|---|---|---|---|---|
| | | Current | | | Extension | Dynamic Hardness | | Capacity/ | Electrode Plate | The Number |
| | | Collector | Temp. | Time | Percentage/% | Surface | Interior | mAh | Breakage | of Leakage |
| 3rd Compar. | Battery 10 | Pure Al Foil | 200° C. | 3 sec. | 2 | 4.7 | 5.9 | 2850 | 5/50 | 0/50 |
| Ex. | Battery 11 | | 250° C. | 1 sec. | 2.5 | 4.3 | 5.8 | 2830 | 2/50 | 0/50 |
| | Battery 12 | | 175° C. | 30 sec. | 1.5 | 4.9 | 5.9 | 2890 | 18/50 | 0/50 |
| | Battery 13 | | 200° C. | 60 sec. | 2.5 | 4.5 | 4.7 | 2760 | 1/50 | 0/50 |
| | Battery 14 | | 250° C. | 20 sec. | 5.5 | 4.2 | 4.3 | 2650 | 0/50 | 0/50 |
| | Battery 15 | | 175° C. | 3 sec. | 1.5 | 5.7 | 5.8 | 2900 | 32/50 | 5/50 |

<Fourth Comparative Example>

Batteries were fabricated in the same manner as for Battery 1 except that a heat treatment atmosphere furnace, instead of the heated roll device, was used as heat treatment facilities. The heat treatment atmosphere furnace was filled with a nitrogen gas.

(Battery 16)

Battery 16 of a fourth comparative example was fabricated in the same manner as for Battery 1 except that the heat treatment was not performed by using the roll, but was performed by setting a heat treatment atmosphere furnace to 200° C., and passing the positive electrode plate of Battery 16 through the heat treatment atmosphere furnace for 3 seconds in Formation of Positive Electrode.

(Battery 17)

Battery 17 of the fourth comparative example was fabricated in the same manner as for Battery 16 except that the heat treatment was performed by setting a heat treatment atmosphere furnace to 250° C., and passing the positive electrode plate of Battery 17 through the heat treatment atmosphere furnace for 1 second in Formation of Positive Electrode.

(Battery 18)

Battery 18 of the fourth comparative example was fabricated in the same manner as for Battery 16 except that the heat treatment was performed by setting a heat treatment atmosphere furnace to 175° C., and passing the positive electrode plate of Battery 18 through the heat treatment atmosphere furnace for 30 seconds in Formation of Positive Electrode.

(Battery 19)

Battery 19 of the fourth comparative example was fabricated in the same manner as for Battery 16 except that the heat treatment was performed by setting a heat treatment atmosphere furnace to 200° C., and passing the positive electrode plate of Battery 19 through the heat treatment atmosphere furnace for 60 seconds in Formation of Positive Electrode.

(Battery 20)

Battery 20 of the fourth comparative example was fabricated in the same manner as for Battery 16 except that the heat treatment was performed by passing the positive electrode plate of Battery 20 through a heat treatment atmosphere furnace at 250° C. for 20 seconds in Formation of Positive Electrode.

(Battery 21)

Battery 21 of the fourth comparative example was fabricated in the same manner as for Battery 16 except that the heat treatment was performed by setting a heat treatment atmosphere furnace to 175° C., and passing the positive electrode plate of Battery 21 through the heat treatment atmosphere furnace for 3 seconds in Formation of Positive Electrode.

For each of the batteries, the extension percentage and the dynamic hardness of the positive electrode and the battery capacity were measured, and an electrode plate breakage evaluation and a winding dislocation evaluation were conducted as in the first example. Results are shown in Table 4.

TABLE 4

| | | Heat | | | | | | | The Number of | |
|---|---|---|---|---|---|---|---|---|---|---|
| | | Treatment | | | Extension | Dynamic Hardness | | Capacity/ | Electrode Plate | The Number |
| | | Method | Temp. | Time | Percentage/% | Surface | Interior | mAh | Breakage | of Leakage |
| 4th Compar. | Battery 16 | Drying Furnace | 200° C. | 3 sec. | 1.5 | 5.8 | 5.9 | 2860 | 38/50 | 17/50 |
| Ex. | Battery 17 | | 250° C. | 1 sec. | 2 | 5.8 | 5.8 | 2850 | 30/50 | 15/50 |
| | Battery 18 | | 175° C. | 30 sec. | 2 | 5.6 | 5.9 | 2890 | 27/50 | 13/50 |
| | Battery 19 | | 200° C. | 60 sec. | 4 | 4.8 | 4.9 | 2720 | 0/50 | 5/50 |
| | Battery 20 | | 250° C. | 20 sec. | 4 | 5 | 5.1 | 2680 | 0/50 | 10/50 |
| | Battery 21 | | 175° C. | 3 sec. | 1.5 | 5.8 | 5.8 | 2900 | 32/50 | 12/50 |

<Fifth Comparative Example>

(Battery 22)

Battery 22 of a fifth comparative example was fabricated in the same manner as for Battery 1 except that the heat treatment by using the heated roll was not performed in Formation of Positive Electrode.

(Battery 23)

Battery 23 of the fifth comparative example was fabricated in the same manner as for Battery 1 except that a rubber binder was used as a binder for the positive electrode of Battery 23, and the heat treatment by using the heated roll was not performed in Formation of Positive Electrode.

For each of the batteries, the extension percentage and the dynamic hardness of the positive electrode and the battery capacity were measured, and an electrode plate breakage evaluation and a winding dislocation evaluation were conducted as in the first example. Results are shown in Table 5.

TABLE 5

| | | | | | | | | | The Number of | |
|---|---|---|---|---|---|---|---|---|---|---|
| | | | | | Extension | Dynamic Hardness | | Capacity/ | Electrode Plate | The Number |
| | | | Temp. | Time | Percentage/% | Surface | Interior | mAh | Breakage | of Leakage |
| 5th Compar. | Battery 22 | PVDF | — | — | 1.5 | 5.8 | 5.9 | 2900 | 42/50 | 25/50 |
| Ex. | Battery 23 | Rubber Binder | — | — | 1.5 | 1.6 | 1.6 | 2890 | 43/50 | 5/50 |

The example and the first to fifth comparative examples are now described in detail based on Tables 1-5.

In the fifth comparative example, both binders, i.e., PVDF and a rubber binder were examined, and as a result, approximately the same battery capacities were obtained for both of the binders. However, a large number of defects was detected as shown in Table 5 when electrode plate breakage was checked during fabrication, and when leakage was checked after the fabrication. This is because the extension percentage of the positive electrode is low, and thus the positive electrode cannot endure the stress in forming a wound body and is broken. Moreover, since the surface is smooth (when PVDF is used), the positive electrode plate slips on the separator, so that the leakage occurs due to winding dislocation. In contrast, when the rubber binder is used, the leakage occurs because the active material is easily peeled off and enters the electrode group.

In Batteries 1-3 of the example, it can be seen that the advantage of achieving a large capacity is obtained without causing the electrode plate breakage and the leakage. This is because the extension percentage (elongation at break) of the positive electrode plate is 3% or larger, i.e., the positive electrode plate has a preferable extension property, the dynamic hardness of the positive electrode mixture layer is 4.5 or larger both at the surface and in the interior of the positive electrode mixture layer, and the dynamic hardness in the interior is larger than that at the surface by 0.8 or more.

The capacity of each of Batteries 4 and 5 of the first comparative example was smaller than that of each of Batteries 1-3 of the example, and than that of each of Batteries 22 and 23 of the fifth comparative example. This is probably because the heat treatment was excessively performed, melting or softening a larger amount of binder in comparison to the case of the positive electrode of Batteries 1-3, so that the surface of the active material was covered with the binder. In contrast, in Battery 6, a large capacity was maintained, but the electrode plate breakage and the leakage occurred. This is probably because the extension percentage of the electrode plate was smaller in comparison to Batteries 1-5, and because the dynamic hardness at the surface of the positive electrode plate was similar to that in the interior of the positive electrode plate, the positive electrode plate hardly lost its shape on the separator, and thus the frictional force was small.

It was found in the second comparative example that the dynamic hardness of the positive electrode plate was significantly reduced when a rubber binder was used as a binder instead of PVDF. Therefore, the electrode plate was fragile as a whole, and the positive electrode active material was easily peeled off during formation of an electrode group, so that the number of leakage tended to be increased in Batteries 7-9.

In the third comparative example, a pure aluminium foil was used as a positive electrode current collector. Since the pure aluminium foil is smaller in softening temperature than an iron-aluminium alloy foil, the pure aluminium foil has to be subjected to a heat treatment at a higher temperature. However, high-temperature, or long heat treatment promotes the thermal melting or softening of the binder, which more likely reduces the capacity. As a result, in Batteries 10-12, the extension percentage was low, and a large number of electrode plate breakage occurred. In Batteries 13 and 14, the structure had a sufficient extension percentage, but the positive electrode was subjected to a high temperature for a long time, so that the entirety of the positive electrode was heated, which resulted in almost the same dynamic hardness at the surface and in the interior. This also resulted in reducing the capacity.

In the fourth comparative example, an atmosphere furnace was used to heat the positive electrode plate instead of a heated roll. In this case, the entirety of the positive electrode plate was heated, so that the positive electrode mixture in Batteries 19 and 20 having a sufficient extension percentage was also heated excessively, thereby reducing the capacity. In contrast, in Batteries 16-18, and 21, the heat treatment was insufficient, so that the extension percentage was not satisfactory, causing a large number of electrode plate breakage.

### OTHER EMBODIMENTS

The heat treatment of the positive electrode plate and the negative electrode plate after the rolling of positive electrode plate and the negative electrode plate may be performed under a given temperature by using hot air subjected to low humidity treatment.

### INDUSTRIAL APPLICABILITY

As described above, the present invention is useful to, for example, consumer power supply having an increased energy density, power supply used on vehicles, power supply for large tools, and the like.

### DESCRIPTION OF REFERENCE CHARACTERS

1 Battery Case
2 Sealing Plate
3 Gasket
4 Positive Electrode
4a Positive Electrode Current Collector
4b Positive Electrode Mixture Layer
4l Positive Electrode Lead
5 Negative Electrode
5a Negative Electrode Current Collector
5b Negative Electrode Mixture Layer
5l Negative Electrode Lead
6 Separator (Porous Insulating Layer)
7a Upper Insulating Plate
7b Lower Insulating Plate
8 Electrode Group
9 Positive Electrode
9a Positive Electrode Current Collector
9b Positive Electrode Mixture Layer
10 Crack
11 Positive Electrode
11a Positive Electrode Current Collector
11b Positive Electrode Mixture Layer
12 Crack
19 Sample Positive Electrode
20a Upper Chuck
20b Lower Chuck
21 Base

1. An electrode plate for a nonaqueous electrolyte secondary battery, the electrode plate comprising:
a current collector; and
an active material mixture layer including an active material and a binder on the current collector, wherein
elongation at break is 3% or larger,
a dynamic hardness at a surface of the active material mixture layer is 4.5 or larger, and
a dynamic hardness in an interior of the active material mixture layer is larger than that at the surface of the active material mixture layer by 0.8 or more.

2. The electrode plate of claim 1, wherein
the active material is a lithium-containing transition metal oxide, and
the binder is a polymeric material containing fluorine.

3. The electrode plate of claim 1, wherein the current collector is an aluminium alloy foil containing iron.

4. A method for fabricating an electrode plate for a nonaqueous electrolyte secondary battery, the method comprising:
(A) forming an active material mixture layer including an active material which is a lithium-containing transition metal oxide and a binder which is a polymeric material containing fluorine on a current collector which is an aluminium alloy foil containing iron; and
(B) heating the active material mixture layer such that a temperature at a surface of the active material mixture layer is higher than that in an interior of the active material mixture layer;
wherein
after (B), a dynamic hardness at the surface of the active material mixture layer is 4.5 or larger, and a dynamic hardness in the interior of the active material mixture layer is larger than that at the surface of the active material mixture layer by 0.8 or more.

5. The method of claim 4, wherein
in (B), the active material mixture layer is brought into contact with a heated roll.

6. The method of claim 4, wherein
in (B), the active material mixture layer is brought into contact with a heated sheet.

7. A nonaqueous electrolyte secondary battery comprising:
the electrode plate of claim 1 as a positive electrode plate.
